(19) United States
(12) Patent Application Publication
(10) Pub. No.: US 2026/0071053 A1
(43) Pub. Date: Mar. 12, 2026

(54) Microsphere Additive for Increased Thermoset Lubricity and/or Barrier Properties

(71) Applicant: Becton, Dickinson and Company, Franklin Lakes, NJ (US)

(72) Inventors: Leandro Forciniti, Haskell, NJ (US); Alfred Wesley Prais, Hewitt, NJ (US)

(21) Appl. No.: 18/830,707

(22) Filed: Sep. 11, 2024

(51) Int. Cl. C08K 7/16; B65D 39/00; C08L 9/00

(52) U.S. Cl. CPC C08K 7/16; B65D 39/0088; C08L 9/00; B65D 2539/006; C08K 2201/005; C08L 2205/18

(57) ABSTRACT

The invention relates, in general, to one or more blended polymeric materials that include therein at least one microsphere additive that are added thereto to produce a self-lubricating effect in same. In one embodiment, the at least one microsphere additive is formed from a suitable polyethylene compound and is added to a suitable base polymeric and/or rubber compound to produce a blended polymeric material that is self-lubricating. In one instance, the at least one polyethylene microsphere additive is formed from an ultra-high molecular weight polyethylene powder.

### BACKGROUND OF THE INVENTION

### FIELD OF THE INVENTION

The invention relates, in general, to one or more blended polymeric materials that include therein at least one microsphere additive, and preferably two polyethylene microsphere additives, that are added thereto to produce a self-lubricating effect in same. In one embodiment, the at least one microsphere additive is formed from a suitable polyethylene compound and is added to a suitable base polymeric and/or rubber compound to produce a blended polymeric material that is self-lubricating. In one instance, the at least one polyethylene microsphere additive is formed from an ultra-high molecular weight polyethylene powder.

### DESCRIPTION OF THE RELATED ART

Certain devices require slow and controlled initiation and maintenance of sliding movement of one surface over another surface. It is well known that two stationary surfaces having a sliding relationship often exhibit sufficient resistance to initiation of movement that gradually increased force applied to one of the surfaces does not cause movement until a threshold force is reached, at which point a sudden sliding or shearing separation of the surfaces takes place. This sudden separation of stationary surfaces into a sliding relationship is herein referred to as “breakout” or “breakloose”.

“Breakout force” refers to the force required to overcome static friction between surfaces of a syringe assembly that has been previously moved in a sliding relationship, but has been stationary (“parked” or not moved) for a short period of time (for example, milliseconds to hours). A less well known but important frictional force is “breakloose force”, which refers to the force required to overcome static friction between surfaces of a syringe assembly that have not been previously moved in a sliding relationship or have been stationary for longer periods of time, often with chemical or material bonding or deformation of the surfaces due to age, sterilization, temperature cycling, or other processing.

Breakout and breakloose forces are particularly troublesome in liquid dispensing devices, such as syringes, used to deliver small, accurately measured quantities of a liquid by smooth incremental line to line advancement of one surface over a second surface. The problem is also encountered in devices using stopcocks, such as burets, pipets, addition funnels, and the like where careful dropwise control of flow is desired.

The problems of excessive breakout and breakloose forces are related to friction. Friction is generally defined as the resisting force that arises when a surface of one substance slides, or tends to slide, over an adjoining surface of itself or another substance. Between surfaces of solids in contact, there may be two kinds of friction: (1) the resistance opposing the force required to start to move one surface over another, conventionally known as static friction, and (2) the resistance opposing the force required to move one surface over another at a variable, fixed, or predetermined speed, conventionally known as kinetic friction.

The force required to overcome static friction and induce breakout or breakloose is referred to as the “breakout force” or “breakloose force”, respectively, and the force required to maintain steady slide of one surface over another after breakout or breakloose is referred to as the “sustaining force”. Two main factors, sticktion and inertia, contribute to static friction and thus to the breakout or breakloose force. The term “stick” or “sticktion” as used herein denotes the tendency of two surfaces in stationary contact to develop a degree of adherence to each other. The term “inertia” is conventionally defined as the indisposition to motion which must be overcome to set a mass in motion. In the context of the present invention, inertia is understood to denote that component of the breakout or breakloose force which does not involve adherence.

Breakout or breakloose forces, in particular the degree of stick, vary according to the composition of the surfaces. In general, materials having elasticity show greater stick than non-elastic materials. The length of time that surfaces have been in stationary contact with each other also influences breakout and/or breakloose forces. In the syringe art, the term “parking” denotes storage time, shelf time, or the interval between filling and discharge. Parking time generally increases breakout or breakloose force, particularly if the syringe has been refrigerated or heated during parking.

A conventional approach to overcoming breakout or breakloose has been application of a lubricant to a surface to surface interface. Common lubricants used are silicone oils (e.g., polydimethylsiloxane silicone oils) and/or hydrocarbon oils (e.g., mineral oils, peanut oil, vegetable oils, and the like) which are typically applied to the inside of a syringe or drug container and often the surface of the mating rubber ("stopper" or "plunger" component). Such products have various disadvantages of: (i) being soluble in a variety of fluids, such as vehicles commonly used to dispense medicaments; and/or (ii) being unsuitable for various biologic families of drugs that contain proteins as these drugs. With regard to item (ii) such biologic drugs are much more sensitive to their surroundings among them oil which when used inside a drug syringe or container designed to store them, can cause the drug to aggregate, rendering the medicament adulterated and no longer fit for use. Additionally, the various oils used to lubricate the barrel migrates from the location it is needed and can contribute to other quality problems like attraction of foreign matter and interfering with downstream operations like primary container labeling. Furthermore, these lubricants are subject to air oxidation resulting in viscosity changes and objectionable color development. Further, they are particularly likely to migrate from the surface to surface interface. Such lubricant migration is generally thought to be responsible for the increase in breakout or breakloose force with time in parking.

Also, from a manufacturing viewpoint applying an oil-based lubricant accurately requires high precision dispensing and metering equipment, which is costly to design, build, and maintain in a stare of control. Even in the best case there exists a practical limit to how well minute volumes of oil can be atomized and distributed on any surface. Efforts to apply the oil in smaller final amounts using solvents to dilute them during application (similar to thinning paint) is effective but has serious EHS (Environmental Health and Safety) concerns. Other methods such as using an oil emulsion may reduce EHS risk and may be effective, but they often require post curing processes, and they introduce other materials into the container like surfactants which can pose other considerations for ultra-sensitive drug molecules.

Given the above, to achieve syringe plunger gliding forces that are acceptable to health care personnel current state of the art has been for many years, the application of a suitable oil (usually polydimethylsiloxane “silicone” to the inside of a syringe or drug container and often the surface of the mating rubber (“stopper” or “plunger” component). This method is well known, and is proven functionally, industrially, and financially effective. It works well enough with many legacy drugs that are non-sensitive like standard vaccines, anticoagulants, and the like.

However, given the rapid advances in various biologic families of drugs that contain proteins, which are much more sensitive to their surroundings (among them oil which when used inside a drug syringe or container designed to store them), there is a need for a drug container without lubricant applied to its drug contacting surfaces.

Thus, in one embodiment, the present invention seeks to realize adequate gliding forces suitable to maintain container closure and minimize the risk of leachable compound diffusion into a drug by incorporating a specific mixture of microsphere-based polymeric composition, emulsion or powder and/or other additives into the base polymer/rubber formulation itself. Use of a plunger stopper made from such a material would have the advantage of keeping the syringe barrel free of silicone, and when used at a suitable loading level achieving reinforcement of the base stopper rubber material (e.g., mechanical properties).

### SUMMARY OF THE INVENTION

The invention relates, in general, to one or more blended polymeric materials that include therein at least one microsphere additive that are added thereto to produce a self-lubricating effect in same. In one embodiment, the at least one microsphere additive is formed from a suitable polyethylene compound and is added to a suitable base polymeric and/or rubber compound to produce a blended polymeric material that is self-lubricating. In one instance, the at least one polyethylene microsphere additive is formed from an ultra-high molecular weight polyethylene powder.

According to one aspect, the present invention is directed to a blended elastomeric, polymeric, and/or rubber formulation (hereinafter just “blended polymeric material”) that comprises at least one base polymeric material; and at least one microsphere additive, wherein the base polymeric material and the at least one microsphere additive are blended together to yield a blended polymeric material that is self-lubricating.

In another embodiment, the present invention is directed to a stopper comprising a stopper body; and at least one sealing rib formed thereon, wherein both the stopper body and the at least one sealing rib are formed from at least one base polymeric material; and at least one microsphere additive, wherein the base polymeric material and the at least one microsphere additive are blended together to yield a blended polymeric material that is self-lubricating

In still another embodiment, the present invention is directed to a blended elastomeric, polymeric, and/or rubber formulation (hereinafter just “blended polymeric material”) that comprises an ultra-high weight polyethylene microsphere powder that is self-lubricating when added to at least one base polymeric material as disclosed herein.

Clause 1: A blended polymeric material comprising: at least one base polymeric material; and at least one microsphere additive, wherein the base polymeric material and the at least one microsphere additive are blended together to yield a blended polymeric material that is self-lubricating.

Clause 2: The blended polymeric material of clause 1, wherein the at least one microsphere additive is present in the at least one blended polymeric material at a range of about 26 percent by weight to about 42 percent by weight and preferably 30 percent by weight to about 38 percent by weight, based on the weight of the base polymeric material present.

Clause 3: The blended polymeric material of any of clause 1 or clause 2, wherein the at least one microsphere additive is selected from ultra-high molecular weight polyethylene powder.

Clause 4: The blended polymeric material of clause 3, wherein the at least one ultra-high molecular weight polyethylene powder microsphere additive has a weight average molecular weight (Mw) in the range of about 2,000,000 g/mol to about 7,500,000 g/mol.

Clause 5: The blended polymeric material of any of clause 3 or clause 4, wherein the at least one ultra-high molecular weight polyethylene powder microsphere additive has a particle size in the range of about 10 μm to about 40 μm preferably 20 μm to about 29 μm.

Clause 6: The blended polymeric material of any of clauses 1 to 5, wherein the blended polymeric material further comprises at least one plasticizer and at least one filler.

Clause 7: The blended polymeric material of clause 6, wherein the at least one plasticizer is present in the blended polymeric material in an amount less than or equal to about 30 percent by weight or alternately 15 percent by weight based on the weight amount of the one or more base polymeric materials present.

Clause 8: The blended polymeric material of any of clause 6 or clause 7, wherein the at least one filler is present in the blended polymeric material in an amount less than or equal to about 15 percent by weight based on the weight amount of the one or more base polymeric materials present.

Clause 9: The blended polymeric material of any of clauses 6 to 8, wherein the ratio of the weight amount of the at least one plasticizer to the weight amount of the at least one filler present in the blended polymeric material is about 1:2.

Clause 10: The blended polymeric material of any of clauses 1 to 9, wherein the base polymeric material is an ultra-low Tg polybutadiene thermoset rubber having a glass transition temperature (Tg) that is less than or equal to about -50 °C.

Clause 11: A stopper comprising: a stopper body; and at least one sealing rib formed on the stopper body, wherein the stopper body and the at least one sealing rib are formed from a blended polymeric material comprising: at least one base polymeric material; and at least one microsphere additive, wherein the base polymeric material and the at least one microsphere additive are blended together to yield a blended polymeric material that is self-lubricating.

Clause 12: The stopper of clause 11, wherein the at least one microsphere additive is present in the at least one blended polymeric material at a range of about 30 percent by weight to about 38 percent by weight based on the weight of the base polymeric material present.

Clause 13: The stopper of any of clause 11 or clause 12, wherein the at least one microsphere additive is selected from ultra-high molecular weight polyethylene powder.

Clause 14: The stopper of clause 13, wherein the at least one ultra-high molecular weight polyethylene powder microsphere additive has a weight average molecular weight (Mw) in the range of about 2,000,000 g/mol to about 7,500,000 g/mol.

Clause 15: The stopper of any of clause 13 or clause 14, wherein the at least one ultra-high molecular weight polyethylene powder microsphere additive has a particle size in the range of about 10 μm to about 40 μm.

Clause 16: The stopper of any of clause 13 or clause 14, wherein the at least one ultra-high molecular weight polyethylene powder microsphere additive has a particle size in the range of about 10 μm to about 30 μm.

Clause 17: The stopper of any of clauses 11 to 16, wherein the blended polymeric material further comprises at least one plasticizer and at least one filler.

Clause 18: The stopper of clause 17, wherein the at least one plasticizer is present in the blended polymeric material in an amount less than or equal to about 15 percent by weight based on the weight amount of the one or more base polymeric materials present.

Clause 19: The stopper of any of clause 17 or clause 18, wherein the at least one filler is present in the blended polymeric material in an amount less than or equal to about 15 percent by weight based on the weight amount of the one or more base polymeric materials present.

Clause 20: The stopper of any of clauses 17 to 19, wherein the ratio of the weight amount of the at least one plasticizer to the weight amount of the at least one filler present in the blended polymeric material is about 1:2.

Clause 21: The stopper of any of clauses 11 to 20, wherein the base polymeric material is an ultra-low Tg polybutadiene thermoset rubber having a glass transition temperature (Tg) that is less than or equal to about -50°C.

### BRIEF DESCRIPTION OF THE DRAWINGS

FIG. 1 is perspective view of an exemplary syringe with which embodiments of the disclosure may be implemented;

FIG. 2 is a perspective view of the syringe of FIG. 1 showing a needle shield covering a distal end of the syringe; and

FIG. 3 is a perspective view of a stopper according to a first embodiment of the present invention.

### DESCRIPTION OF THE INVENTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

As noted above, the invention relates, in general, to one or more blended polymeric materials that include therein at least one microsphere additive that are added thereto to produce a self-lubricating effect in same. In one embodiment, the at least one microsphere additive is formed from a suitable polyethylene compound and is added to a suitable base polymeric and/or rubber compound to produce a blended polymeric material that is self-lubricating. In one instance, the at least one polyethylene microsphere additive is formed from an ultra-high molecular weight polyethylene powder.

Initially, a discussion of one set of exemplary stopper designs will be undertaken. However, it is to be understood that the following stopper design is only representative and the present invention is not limited to solely the designs disclosed herein. Rather, any stopper design where total sealing is desired can be utilized in conjunction with the present invention.

For purposes of the description hereinafter, the terms “upper”, “lower”, “right”, “left”, “vertical”, “horizontal”, “top”, “bottom”, “lateral”, “longitudinal”, and derivatives thereof, shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

As used herein, the terms “rubber composition”, “rubber material”, “compounded rubber”, “compounded rubber material”, “rubber compound”, “polymer composition”, “polymer material”, “compounded polymer”, “compounded polymer material”, and “polymer compound” are used interchangeably to refer to a polymer/rubber which has been blended or mixed with one or more various ingredients and/or materials as described herein. Also, the terms “polymer” and “polymeric” are used interchangeably to refer to a polymer/rubber which has been blended or mixed with one or more various ingredients and/or materials as described herein.

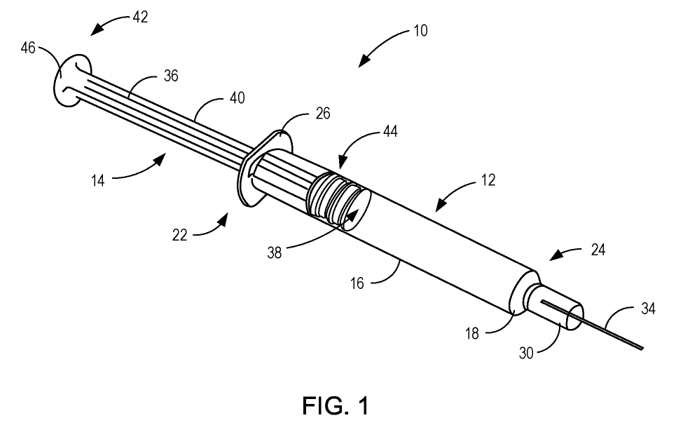

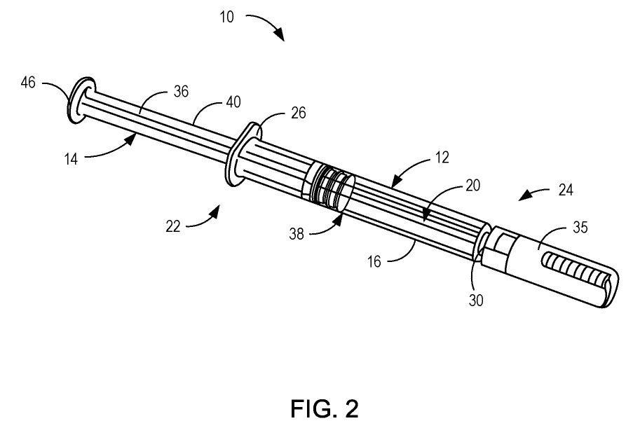

Referring to FIGS. 1 and 2, shown is a non-limiting embodiment of a syringe 10 with which aspects or embodiments of the disclosure may be implemented. According to some aspects of the disclosure, syringe 10 may be provided as a prefilled syringe, which provides the convenience of rapidly delivering the liquid therein to a patient without the need to first aspirate the medication from another container and meter its volume.

As shown in FIGS. 1 and 2, syringe 10 generally includes a syringe barrel 12 and a plunger assembly 14. Plunger assembly 14 is movable within syringe barrel 12 along a longitudinal axis to an advanced position to facilitate administering of an injectable fluid (e.g., medication) to a patient, for example. Syringe barrel 12 is formed from a suitable glass, metal, ceramic or plastic material and includes a generally cylindrical outer wall 16 and an end member 18 that collectively define a chamber 20 for retaining fluid therein. Syringe barrel 12 includes an open proximal end 22 configured to receive plunger assembly 14 therein and a distal end 24 at which end member 18 is positioned. Proximal end 22 of syringe barrel 12 may include a flange 26 to facilitate handling and positioning of syringe 10 and to maintain the relative position of syringe barrel 12 with respect to plunger assembly 14 during medication administration. At distal end 24, end member 18 may include a hub 30 which narrows with respect to cylindrical outer wall 16 and extends out distally therefrom. Hub portion 30 is formed as a partially hollow member that defines a channel therethrough in fluid communication with chamber 20.

In some embodiments, a needle 34 is attached to hub portion 30 within the channel, such as by being glued or otherwise secured to hub portion 30. According to some aspects of the disclosure, syringe 10 may further include a cover 35 that couples to hub portion 30 of syringe barrel 12 to protect needle 34.

While not shown in FIGS. 1 and 2, it is recognized that in other embodiments syringe 10 may be configured as a luer tip or luer lock syringe, where hub portion 30 transitions to a luer connection. As one example, syringe 10 may include a luer lock per ISO 594.

Plunger assembly 14 of syringe 10 is formed of an elongate plunger rod 36 (more generally “plunger 36,” as used hereafter) and a plunger head or stopper 38. Plunger 36 may include a main body 40 extending between a plunger proximal end 42 and a plunger distal end 44. A thumb press 46 is positioned at plunger proximal end 42 that may be engaged by a thumb (or other finger) of the user to apply a distally directed force to plunger assembly 14 to move plunger 36 with respect to syringe barrel 12. Plunger distal end 44 is configured to mate with stopper 38. In other embodiments, plunger distal end 44 may be a threaded end that mates with stopper 38.

Stopper 38 of plunger assembly 14 is positioned at plunger distal end 44 so as to be movable along with plunger 36 within chamber 20 of syringe barrel 12. That is, as a distally-directed force is applied to plunger rod 36 (such as to thumb press 46), both plunger rod 36 and stopper 38 are caused to move distally through syringe barrel 12, with stopper 38 configured to maintain a seal with an inner surface of syringe barrel 12 as it is moved therethrough.

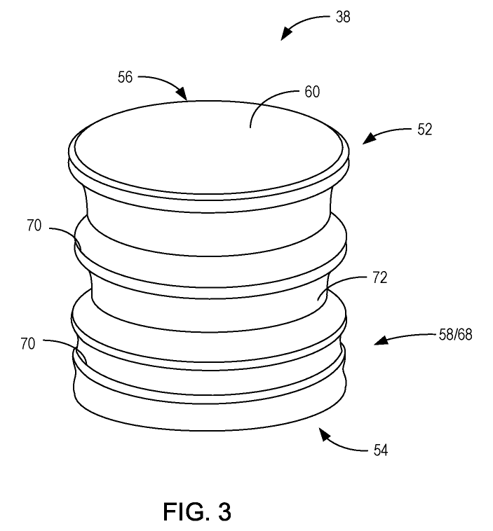

Referring now to FIG. 3, and with continued reference to FIGS. 1 and 2, the structure of an exemplary stopper 38 that may be included in syringe 10 is shown in greater detail, according to a non-limiting aspect or embodiment of the disclosure. Stopper 38 is defined by a main body 52 that includes a proximal end 54 and a distal end 56. Proximal end 54 may be configured as an open proximal end that engages with the distal end of plunger 36, while distal end 56 is configured as a closed distal end configured to engage with barrel 12 of syringe 10. The closed distal end 56 of main body 52 includes a generally cylindrical portion 58 and a roof portion 60. In some embodiments, roof portion 60 is configured as a flat surface to provide closed distal end 56, but it is recognized that roof portion 60 may instead be configured as a conical or domed surface, as other non-limiting examples.

In some embodiments, and as known in the art, main body 52 of stopper 38 may be partially hollow and sized and configured to receive distal end 44 of plunger 36 therein. Main body 52 of stopper 38 defines an inner cavity (not shown, but various embodiments are known to those of skill in the art) that, in some embodiments, may include a threaded inner surface that is configured to receive and mate with a threaded distal end 44 of plunger 36. In other embodiments, the inner cavity may define an inner contoured surface having a notch therein that is configured to receive a flanged extension member of plunger 36.

In other embodiments, and as known in the art, main body 52 of stopper 38 is configured as a solid member and distal end 44 of plunger 36 is configured as a “pusher rod” that engages a proximal face of the stopper 38 to push the stopper 38 and advance it through the syringe barrel.

Outer surface 68 of cylindrical portion 58 of main body 52 includes one or more ribs thereon that extend circumferentially around entire outer surface 68 of cylindrical portion 58. In each of the illustrated embodiments, a plurality of ribs 70 are included on stopper 38, but it is recognized that other embodiments could include only a single rib 70. Ribs 70 may be formed integrally with main body 52, such as via a molding process. The plurality of ribs 70 may include two ribs 70, with a first or distal rib positioned toward distal end 56 of main body 52 and a second or proximal rib positioned toward proximal end 54 of main body 52, or may include three or more ribs 70 spaced apart along cylindrical portion 58 – with an inter-rib region 72 provided between each adjacent pair of ribs. Inter-rib region 72 of cylindrical portion 58 may have a generally flat outer surface 68 or a curved outer surface 68.

Generally, stopper 38 is be made from a material that is different from the material of plunger 36 and that is capable of forming a tight seal with syringe barrel 12 as it is advanced therethrough. Alternatively, if so desired, stopper 38 is be made from a material that is similar to, or the same as, the material of plunger 36 and that is also capable of forming a tight seal with syringe barrel 12 as it is advanced therethrough. Given this the nature of the base polymeric material of the present invention which is used to form a blend with the at least one microsphere additive disclosed herein will be described below.

A stopper in accordance with the present invention is formed to have a stopper body with one rib, two ribs, or even three or more ribs thereon, where at least one such rib is a sealing rib. The shape of such stopper is not critical and can be round, square, a composite shape, etc. The shape of the stopper is this example is such that the combination of the contact geometry-width, rubber modulus and roughness achieve along a continuous path along the sealing surface of any sealing element 90 percent or more of the indentation modulus of a corresponding film of the base polymeric material used to form such a stopper (as defined in more detail above). The material used to form such a stopper is any rubber material described herein which achieves a Young’s modulus of about 5 MPa to about 10 MPa, or even about 6 MPa to about 9 MPa (as defined in more detail above). In one embodiment, the base material used to form the stopper of the present invention contains one or more suitable fillers, and can optionally even be a cross-linked base polymeric material. Suitable filler materials for the base polymeric materials include, but are not limited to, various silica compounds including silica compounds treated with one or more coupling agents (e.g., a silane coupling agent), single or multiple walled carbon nanotubes (CNT). Additionally, other suitable filler materials for the base polymeric materials disclosed herein are known in the art and as such are omitted herein for the sake of brevity.

In another embodiment, the blended polymeric material can be used to form any other type of polymeric item where both sealing and gliding functions are desired.

### BASE POLYMERIC MATERIAL

In one embodiment, suitable stopper base polymeric materials include, but are not limited to, one or more polyolefins (e.g., PE, PP, and their copolymers), one or more polyamides (e.g., nylons), one or more polyesters (e.g., PET), one or more polystyrenes, one or more polyurethanes, one or more polycarbonates, one or more acrylonitrile-butadiene-styrenes, one or more fluoropolymers, one or more polyacrylates, one or more elastomeric rubbers, or blends of any two or more thereof that meet at least one of the Young’s modulus and/or Shore A properties defined above. In another embodiment, suitable stopper materials include, but are not limited to, base polymeric materials selected from one or more polyisoprenes (including, but not limited to, natural rubber), one or more polyisobutylenes, one or more synthetic polyisoprenes, one or more polybutadienes (commonly referred to collectively as butadiene rubbers), one or more chloroprene rubbers (e.g., polychloroprene, neoprene, etc.), one or more butyl rubbers (i.e., copolymers of isobutene and isoprene), one or more halogenated butyl rubbers (e.g., chloro butyl rubber or bromo butyl rubber), one or more styrene-butadiene rubbers (i.e., copolymers of styrene and butadiene), one or more nitrile rubbers (i.e., copolymers of butadiene and acrylonitrile), one or more hydrogenated nitrile rubbers, natural rubber, one or more ethylene propylene rubbers, one or more ethylene propylene diene rubbers, or blends of any two or more thereof. In another embodiment, suitable stopper base polymeric materials include, but are not limited to, one or more butadiene rubbers, one or more halogenated butyl rubbers (e.g., chloro butyl rubber or bromo butyl rubber), or blends of any two or more thereof.

In some embodiments, suitable stopper base materials are selected from one or more of the materials listed above and further have a Young's modulus (also known as the tensile modulus, elastic modulus or traction modulus) in a range of about 5 MPa to about 10 MPa, or from about 5.25 MPa to about 9.75 MPa, or from about 5.5 MPa to about 9.5 MPa, or from about 5.75 MPa to about 9.25 MPa, or from about 6 MPa to about 9 MPa, or from about 6.25 MPa to about 8.75 MPa, or from about 6.5 MPa to about 8.5 MPa, or from about 6.75 MPa to about 8.25 MPa, or from about 7 MPa to about 8 MPa, or from about 7.25 MPa to about 7.75 MPa, or even about 7.5 MPa. In another embodiment, suitable stopper base materials are selected from one or more of the materials listed above and further have a Young's modulus (also known as the tensile modulus, elastic modulus or traction modulus) in a range of about 5 MPa to about 10 MPa, or from about 5.1 MPa to about 9.9 MPa, or from about 5.2 MPa to about 9.8 MPa, or from about 5.3 MPa to about 9.7 MPa, or from about 5.4 MPa to about 9.6 MPa, or from about 5.5 MPa to about 9.5 MPa, or from about 5.6 MPa to about 9.4 MPa, or from about 5.7 MPa to about 9.3 MPa, or from about 5.8 MPa to about 9.2 MPa, or from about 5.9 MPa to about 9.1 MPa, or from about 6 MPa to about 9 MPa, or from about 6.1 MPa to about 8.9 MPa, or from about 6.2 MPa to about 8.8 MPa, or from about 6.3 MPa to about 8.7 MPa, or from about 6.4 MPa to about 8.6 MPa, or from about 6.5 MPa to about 8.5 MPa, or from about 6.6 MPa to about 8.4 MPa, or from about 6.7 MPa to about 8.3 MPa, or from about 6.8 MPa to about 8.2 MPa, or from about 6.9 MPa to about 8.1 MPa, or from about 7 MPa to about 8 MPa, or from about 7.1 MPa to about 7.9 MPa, or from about 7.2 MPa to about 7.8 MPa, or from about 7.3 MPa to about 7.7 MPa, or from about 7.4 MPa to about 7.6 MPa, or even about 7.5 MPa. Here, as well as elsewhere in the specification and claims, individual numerical values can be combined to form additional, or even new/non-disclosed, numerical ranges.

The desired Shore A hardness of the afore-mentioned suitable base polymeric materials for the present invention is between about 50 to about 85, or from about 55 to about 80, or from about 60 to about 75, or from about 65 to about 70, or even about 67.5. In another embodiment, the base polymeric material of the present invention has a Shore A hardness of about 50 to about 85, or from about 52 to about 83, or from about 54 to about 81, or from about 56 to about 79, or from about 58 to about 77, or from about 60 to about 75, or from about 62 to about 73, or from about 64 to about 71, or from about 66 to about 69, or even about 67.5. Here, as well as elsewhere in the specification and claims, individual numerical values can be combined to form additional, or even new/non-disclosed, numerical ranges.

In another embodiment, the base polymeric material is any suitable polymeric material with either a Young’s modulus and/or a Shore A hardness in one of the ranges noted above in combination with a high Mooney viscosity, where the base polymeric material’s Mooney viscosity is determined before curing. A high Mooney rubber is defined as rubber having Mooney viscosity (as defined in ASTM D1646-19a) greater than about 40, or greater than about 45, or greater than about 50, or greater than about 55, or greater than about 60, or greater than about 65, or even greater than about 70. Here, as well as elsewhere in the specification and claims, individual numerical values can be combined to form additional, or even new/non-disclosed, numerical ranges.

Suitable high Mooney viscosity rubbers include, but are not limited to, one or more polybutadiene rubbers, one or more polyisobutylene, one or more polyisoprene rubbers, natural rubber, one or more ethylene propylene rubbers, one or more ethylene propylene diene rubbers, one or more styrene-butadiene rubbers, or blends of any two or more thereof.

In one embodiment, the surface roughness of the base polymeric material that is used to form the stopper of the present invention is independently in a range of about 0.0001 microns to about 6 microns, or from about 0.0002 microns to about 5.9 microns, or from about 0.0003 microns to about 5.8 microns, or from about 0.0004 microns to about 5.7 microns, or from about 0.0005 microns to about 5.6 microns, or from about 0.0006 microns to about 5.5 microns, or from about 0.0007 microns to about 5.4 microns, or from about 0.0008 microns to about 5.3 microns, or from about 0.0009 microns to about 5.2 microns, or from about 0.001 microns to about 5.1 microns, or from about 0.0011 microns to about 5 microns, or from about 0.0012 microns to about 4.9 microns, or from about 0.0013 microns to about 4.8 microns, or from about 0.0014 microns to about 4.7 microns, or from about 0.0015 microns to about 4.6 microns, or from about 0.0016 microns to about 4.5 microns, or from about 0.0017 microns to about 4.4 microns, or from about 0.0018 microns to about 4.3 microns, or from about 0.0019 microns to about 4.2 microns, or from about 0.002 microns to about 4.1 microns, or from about 0.0021 microns to about 4 microns, or from about 0.0022 microns to about 3.9 microns, or from about 0.0023 microns to about 3.8 microns, or from about 0.0024 microns to about 3.7 microns, or from about 0.0025 microns to about 3.6 microns, or from about 0.0026 microns to about 3.5 microns, or from about 0.0027 microns to about 3.4 microns, or from about 0.0028 microns to about 3.3 microns, or from about 0.0029 microns to about 3.2 microns, or from about 0.003 microns to about 3.1 microns, or from about 0.0031 microns to about 3 microns, or from about 0.0032 microns to about 2.9 microns, or from about 0.0033 microns to about 2.8 microns, or from about 0.0034 microns to about 2.7 microns, or from about 0.0035 microns to about 2.6 microns, or from about 0.0036 microns to about 2.5 microns, or from about 0.0037 microns to about 2.4 microns, or from about 0.0038 microns to about 2.3 microns, or from about 0.0039 microns to about 2.2 microns, or from about 0.004 microns to about 2.1 microns, or from about 0.0041 microns to about 2 microns, or from about 0.0042 microns to about 1.9 microns, or from about 0.0043 microns to about 1.8 microns, or from about 0.0044 microns to about 1.7 microns, or from about 0.0045 microns to about 1.6 microns, or from about 0.0046 microns to about 1.5 microns, or from about 0.0047 microns to about 1.4 microns, or from about 0.0048 microns to about 1.3 microns, or from about 0.0049 microns to about 1.2 microns, or from about 0.005 microns to about 1.1 microns, or from about 0.0051 microns to about 1 micron, or from about 0.0052 microns to about 0.9 microns, or from about 0.0053 microns to about 0.8 microns, or from about 0.0054 microns to about 0.7 microns, or from about 0.0055 microns to about 0.6 microns, or from about 0.0056 microns to about 0.5 microns, or from about 0.0057 microns to about 0.4 microns, or from about 0.0058 microns to about 0.3 microns, or from about 0.0059 microns to about 0.2 microns, or from about 0.006 microns to about 0.1 microns, or from about 0.0065 microns to about 0.095 microns, or from about 0.007 microns to about 0.09 microns, or from about 0.0075 microns to about 0.085 microns, or from about 0.008 microns to about 0.08 microns, or from about 0.0085 microns to about 0.075 microns, or from about 0.009 microns to about 0.07 microns, or from about 0.0095 microns to about 0.065 microns, or from about 0.01 microns to about 0.06 microns, or from about 0.015 microns to about 0.055 microns, or from about 0.02 microns to about 0.05 microns, or from about 0.025 microns to about 0.045 microns, or from about 0.03 microns to about 0.04 microns, or even 0.035 microns as measured at 50X via optical interferometry. Here, as well as elsewhere in the specification and claims, individual numerical values can be combined to form additional, or even new/non-disclosed, numerical ranges.

In one embodiment, the base polymeric material that is used to form a stopper of the present invention has a rubber substrate modulus in a range of about 4 MPa to about 8 MPa, or from about 4.25 MPa to about 7.75 MPa, or from about 4.5 MPa to about 7.5 MPa, or from about 4.75 MPa to about 7.25 MPa, or from about 5 MPa to about 7 MPa, or from about 5.25 MPa to about 6.75 MPa, or from about 5.5 MPa to about 6.5 MPa, or from about 5.75 MPa to about 6.25 MPa, or even about 6 MPa as measured at the limit of the stress versus strain of a molded part formed from a desired base polymeric material and is suitable to be blended with at least one microsphere additive as described herein. Here, as well as elsewhere in the specification and claims, individual numerical values can be combined to form additional, or even new/non-disclosed, numerical ranges.

In another embodiment, the base polymeric material that can be used to form a stopper in accordance with the present invention has a stress relaxation of between about 0 percent and about 35 percent as determined from initial contact max pressure. In still another embodiment, the base polymeric material that is used to form a stopper of the present invention has a stress relaxation of between about 0 percent and about 30 percent, or between about 2.5 percent and about 27.5 percent, or between about 5 percent and about 25 percent, or between about 7.5 percent and about 22.5 percent, or between about 10 percent and about 20 percent, or between about 12.5 percent and about 17.5 percent, or even about 15 percent as determined from initial contact max pressure. Here, as well as elsewhere in the specification and claims, individual numerical values can be combined to form additional, or even new/non-disclosed, numerical ranges.

In one embodiment, the base polymeric material for use in forming the stopper of the present invention is any suitable butyl rubber material, or other polymeric or rubber material, having a Shore A hardness in a range of about 50 to about 85, or from about 51 to about 84, or from about 52 to about 83, or from about 53 to about 82, or from about 54 to about 81, or from about 55 to about 80, or from about 56 to about 79, or from about 57 to about 78, or from about 58 to about 77, or from about 59 to about 76, or from about 60 to about 75, or from about 61 to about 74, or from about 62 to about 73, or from about 63 to about 72, or from about 64 to about 71, or from about 65 to about 70, or from about 66 to about 69, or from about 67 to about 68, or even about 67.5. In another embodiment, the base polymeric material for use in forming the stopper of the present invention is any suitable butyl rubber material having a Young’s modulus in a range of about 5 MPa to about 10 MPa, or from about 5.1 MPa to about 9.9 MPa, or from about 5.2 MPa to about 9.8 MPa, or from about 5.3 MPa to about 9.7 MPa, or from about 5.4 MPa to about 9.6 MPa, or from about 5.5 MPa to about 9.5 MPa, or from about 5.6 MPa to about 9.4 MPa, or from about 5.7 MPa to about 9.3 MPa, or from about 5.8 MPa to about 9.2 MPa, or from about 5.9 MPa to about 9.1 MPa, or from about 6 MPa to about 9 MPa, or from about 6.1 MPa to about 8.9 MPa, or from about 6.2 MPa to about 8.8 MPa, or from about 6.3 MPa to about 8.7 MPa, or from about 6.4 MPa to about 8.6 MPa, or from about 6.5 MPa to about 8.5 MPa, or from about 6.6 MPa to about 8.4 MPa, or from about 6.7 MPa to about 8.3 MPa, or from about 6.8 MPa to about 8.2 MPa, or from about 6.9 MPa to about 8.1 MPa, or from about 7 MPa to about 8 MPa, or from about 7.1 MPa to about 7.9 MPa, or from about 7.2 MPa to about 7.8 MPa, or from about 7.3 MPa to about 7.7 MPa, or from about 7.4 MPa to about 7.6 MPa, or even about 7.5 MPa. In still another embodiment, the base polymeric material for use in forming the stopper of the present invention is any suitable butyl rubber material having a Shore A hardness within one of the above ranges in conjunction with a Young’s modulus within one of the above ranges. Here, as well as elsewhere in the specification and claims, individual numerical values can be combined to form additional, or even new/non-disclosed, numerical ranges.

In another embodiment, the base polymeric material for use in forming the stopper of the present invention is any suitable butyl rubber material having a stress relaxation over a period of 24 hours better than about 20 percent at room temperature (RT), better than about 25 percent at RT, or even better than about 30 percent at RT. In still another embodiment, the base polymeric material for use in forming the stopper of the present invention is any of the base polymeric materials disclosed above that have a stress relaxation better than about 21 percent at room temperature (RT), better than about 22 percent at RT, better than about 23 percent at RT, better than about 24 percent at RT, better than about 25 percent at RT, better than about 26 percent at RT, better than about 27 percent at RT, better than about 28 percent at RT, better than about 29 percent at RT, or even better than about 30 percent at RT. Here, as well as elsewhere in the specification and claims, individual numerical values can be combined to form additional, or even new/non-disclosed, numerical ranges.

In one instance, a high Mooney viscosity bromo-butyl rubber composition is loaded with about 40 phr to about 90 phr reinforcing silica filler with a sulfur donor fast-accelerator type of curing package activated containing a metal oxide and stearic acid. In another instance, the loading range of this bromo-butyl rubber composition with the afore-mentioned silica filler is in a range of about 42 phr to about 88 phr, or from about 44 phr to about 86 phr, or from about 46 phr to about 84 phr, or from about 48 phr to about 82 phr, or from about 50 phr to about 80 phr, or from about 52 phr to about 78 phr, or from about 54 phr to about 76 phr, or from about 56 phr to about 74 phr, or from about 58 phr to about 72 phr, or from about 60 phr to about 70 phr, or from about 62 phr to about 68 phr, or from about 64 phr to about 66 phr, or even about 65 phr silica filler. As used herein, the term per hundred resin (phr) means the amount of an additive, resin, or some other component, by weight as calculated based on 100 parts by weight of the initial polymer, rubber, and/or resin material. Here, as well as elsewhere in the specification and claims, individual numerical values can be combined to form additional, or even new/non-disclosed, numerical ranges.

Some alternative fillers are high reinforcement silica treated with a coupling agent such as a silane coupling agent, high surface area carbon based fillers such as furnace carbon blacks that comply with ASTM N110, N220, N330, N550, N660 standards, single wall and multi-wall carbon nano-tubes, graphene oxide nano-particles, phenolic and resol resin networks, and thermoplastics such as polypropylene. Additional rubber formulations for possible lamination with low melting temperature film (e.g., a suitable ultrahigh molecular weight polyethylene) are high Mooney viscosity bromo butyl rubber formulations having therein a high load (e.g., from about 60 phr to about 70 phr) reinforcing silica filler with a sulfur donor ultra-accelerator type of curing package (metal-organic complex) that has been activated with a metal oxide and a suitable carbamate-type secondary accelerator. In one embodiment the reinforcing silica filler is chosen from silica, sodium silicate, potassium silicate, calcium silicate, magnesium silicate, aluminum silicate. Additional suitable variants of this type of rubber formulation are those that utilize either a high reinforcement level (e.g., from about 60 phr to about 70 phr) of silica treated with a suitable coupling agent (e.g., a silane coupling agent), a dispersion polymer system, and/or a liquid rubber polymer additive (e.g., a suitable butadiene additive). Another variant of these type of rubber formulations utilize a high reinforcement level (e.g., from about 60 phr to 70 phr) of pre-treated silicates. The silica could be pretreated with a silane coupling agent, alkylammonium salts such as octadecylamine and octadecyltrimethylamine, and quaternary amines.

In one embodiment, a suitable filler according to the present invention is any of the filler materials disclosed herein that have a surface area greater than about 100 m²/g, or greater than about 110 m²/g, or greater than about 120 m²/g, or greater than about 130 m²/g, or greater than about 140 m²/g, or greater than about 150 m²/g, or greater than about 160 m²/g, or greater than about 170 m²/g, or greater than about 180 m²/g, or greater than about 190 m²/g, or greater than about 200 m²/g, or greater than about 210 m²/g, or greater than about 220 m²/g, or greater than about 230 m²/g, or greater than about 240 m²/g, or greater than about 250 m²/g, or greater than about 260 m²/g, or greater than about 270 m²/g, or greater than about 280 m²/g, or greater than about 290 m²/g, or even greater than about 300 m²/g. In another embodiment, a suitable filler according to the present invention is any of the filler materials disclosed herein that have a surface area greater than about 325 m²/g, or greater than about 350 m²/g, or greater than about 375 m²/g, or greater than about 400 m²/g, or greater than about 425 m²/g, or greater than about 450 m²/g, or greater than about 475 m²/g, or greater than about 500 m²/g, or greater than about 525 m²/g, or greater than about 550 m²/g, or greater than about 575 m²/g, or even greater than about 600 m²/g. Here, as well as elsewhere in the specification and claims, individual numerical values can be combined to form additional, or even new/non-disclosed, numerical ranges.

In an alternate embodiment the base polymeric material used in forming the stopper of the present invention is any suitable styrene-butadiene, high-cis butadiene, ethylene propylene diene terpolymer, brominated isobutylene paramethyl-styrene terpolymers, chloro or bromo isobutylene-isoprene co-polymer, or any blend thereof having a Shore A hardness in a range of about 60 to about 70, or from about 61 to about 69, or from about 62 to about 68, or from about 63 to about 67, or from about 64 to about 66, or even about 65. In an alternate embodiment one or more of these base polymers are blended with or without reinforcing fillers in combination with a curative package to obtain a Young’s modulus in a range of about 5 MPa to about 8 MPa, or from about 5.1 MPa to about 7.9 MPa, or from about 5.2 MPa to about 7.8 MPa, or from about 5.3 MPa to about 7.7 MPa, or from about 5.4 MPa to about 7.6 MPa, or from about 5.5 MPa to about 7.5 MPa, or from about 5.6 MPa to about 7.4 MPa, or from about 5.7 MPa to about 7.3 MPa, or from about 5.8 MPa to about 7.2 MPa, or from about 5.9 MPa to about 7.1 MPa, or from about 6 MPa to about 7 MPa, or from about 6.1 MPa to about 6.9 MPa, or from about 6.2 MPa to about 6.8 MPa, or from about 6.3 MPa to about 6.7 MPa, or from about 6.4 MPa to about 6.6 MPa, or even about 6.5 MPa. Here, as well as elsewhere in the specification and claims, individual numerical values can be combined to form additional, or even new/non-disclosed, numerical ranges. In these embodiments acceptable cure packages could include sulfur donor fast-accelerator type of curing package activated containing a metal oxide and stearic acid, alternately, organic peroxides with or without type 1 and type 2 co-agents, and rubber maker sulfur in combination with thiazoles, sulfenamides, guanidines, and dithiocarbamates, individually or in unique combinations.

In an alternate embodiment the base polymeric material used in forming the stopper of the present invention is any suitable polymeric material that has a glass transition (Tg) temperature of less than or equal to about 10°C, of less than or equal to about 5°C, of less than or equal to about 0°C, of less than or equal to about -5°C, of less than or equal to about -10°C, of less than or equal to about -15°C, of less than or equal to about -20°C, of less than or equal to about -25°C, of less than or equal to about -30°C, of less than or equal to about -35°C, of less than or equal to about -40°C, of less than or equal to about -45°C, of less than or equal to about -50°C, of less than or equal to about -55°C, of less than or equal to about -60°C, of less than or equal to about -65°C, of less than or equal to about -70°C, of less than or equal to about -75°C, of less than or equal to about -80°C, of less than or equal to about -85°C, of less than or equal to about -90°C, of less than or equal to about -95°C, of less than or equal to about -100°C, of less than or equal to about -105°C, of less than or equal to about -110°C, of less than or equal to about -115°C, or even less than or equal to about -120°C. Here, as well as elsewhere in the specification and claims, individual numerical values can be combined to form additional, or even new/non-disclosed, numerical ranges.

Given the above, in one embodiment, the base polymeric material for the present invention is selected from a polybutadiene thermoset rubber where the glass transition temperature (Tg) is less than or equal to about -50°C, of less than or equal to about -55°C, of less than or equal to about -60°C, of less than or equal to about -65°C, of less than or equal to about -70°C, of less than or equal to about -75°C, of less than or equal to about -80°C, of less than or equal to about -85°C, of less than or equal to about -90°C, of less than or equal to about -95°C, or even less than or equal to about -100°C. Here, as well as elsewhere in the specification and claims, individual numerical values can be combined to form additional, or even new/non-disclosed, numerical ranges.

In another embodiment, the base polymeric material for the present invention is selected from a polybutadiene thermoset rubber where the glass transition temperature noted above and is considered an ultra-low Tg polybutadiene thermoset rubber. However, it should be noted that the present invention is not limited to solely polybutadiene thermoset rubber compounds as the base polymer. Instead, any suitable polymeric material disclosed herein can be used as the base polymeric material for the present invention so long as such polymeric material meets at least one or more of the criteria detailed above.

In still another embodiment, any of the base polymeric materials disclosed for use in conjunction with the stoppers of the present invention can have any combination of two, three or more, or even four or more, of any of the various chemical and/or physical properties disclosed herein.

### Microsphere Additive

In one embodiment, the at least one microsphere additive of the present invention is any suitable polymeric microsphere material that can be incorporated into a base polymeric material and yield a blended polymeric material that is suitable for various medical applications including, but not limited to, various syringe designs and applications.

In one embodiment, the at least one microsphere additive of the present invention is selected from any suitable polymeric microspheres formed from one or more polymers selected from one or more polyethylenes, one or more polypropylenes, on or more polyvinyl chlorides, one or more polystyrenes, one or more polycarbonates, one or more polyetheretherketones, one or more polymethylpentene, one or more acylics such as one or more poly(methyl methacrylates), one or more acrylonitrile butadiene styrene, or even combinations of two or more thereof, three or more thereof, four or more thereof, or even five or more thereof.

In one embodiment, the at least one microsphere additive is formed from a powder containing spherical, or substantially spherical, microsphere particles where at least about 80 percent of the microsphere particles have a particle size (i.e., particle diameter) in the range of about 15 μm to about 35 μm, or from about 16 μm to about 34 μm, or about 17 μm to about 33 μm, or from about 18 μm to about 32 μm, or about 19 μm to about 31 μm, or from about 20 μm to about 30 μm, or from about 21 μm to about 29 μm, or about 22 μm to about 28 μm, or from about 23 μm to about 27 μm, or about 24 μm to about 26 μm, or even about 25 μm. In another embodiment, the microsphere particles have a particle size (i.e., particle diameter) in the range of about 20 μm to about 29 μm. In still another embodiment, at least about 82.5 percent, at least about 85 percent, at least about 87.5 percent, at least 90 percent, at least about 92.5 percent, at least about 95 percent, or even at least about 97.5 percent of the microsphere particles have a particle size (i.e., particle diameter) in one of the ranges listed above. Here, as well as elsewhere in the specification and claims, individual numerical values can be combined to form additional, or even new/non-disclosed, numerical ranges.

In one embodiment, the at least one microsphere additive of the present invention is selected from a suitable UHMWPE (ultra-high molecular weight polyethylene) having a molecular weight in the range (weight average molecular weight (Mw) in grams per mole) of about 2,000,000 g/mol to about 7,500,000 g/mol, of about 2,100,000 g/mol to about 7,400,000 g/mol, of about 2,200,000 g/mol to about 7,300,000 g/mol, of about 2,300,000 g/mol to about 7,200,000 g/mol, of about 2,400,000 g/mol to about 7,100,000 g/mol, of about 2,500,000 g/mol to about 7,000,000 g/mol, of about 2,600,000 g/mol to about 6,900,000 g/mol, of about 2,700,000 g/mol to about 6,800,000 g/mol, of about 2,800,000 g/mol to about 6,700,000 g/mol, of about 2,900,000 g/mol to about 6,600,000 g/mol, of about 3,000,000 g/mol to about 6,500,000 g/mol, of about 3,100,000 g/mol to about 6,400,000 g/mol, of about 3,200,000 g/mol to about 6,300,000 g/mol, of about 3,300,000 g/mol to about 6,200,000 g/mol, of about 3,400,000 g/mol to about 6,100,000 g/mol, of about 3,500,000 g/mol to about 6,000,000 g/mol, of about 3,600,000 g/mol to about 5,900,000 g/mol, of about 3,700,000 g/mol to about 5,800,000 g/mol, of about 3,800,000 g/mol to about 5,700,000 g/mol, of about 3,900,000 g/mol to about 5,600,000 g/mol, of about 4,000,000 g/mol to about 5,500,000 g/mol, of about 4,100,000 g/mol to about 5,400,000 g/mol, of about 4,200,000 g/mol to about 5,300,000 g/mol, of about 4,300,000 g/mol to about 5,200,000 g/mol, of about 4,400,000 g/mol to about 5,100,000 g/mol, of about 4,500,000 g/mol to about 5,000,000 g/mol, of about 4,600,000 g/mol to about 4,900,000 g/mol, of about 4,700,000 g/mol to about 4,800,000 g/mol, of even about 4,750,000 g/mol. Here, as well as elsewhere in the specification and claims, individual numerical values can be combined to form additional, or even new/non-disclosed, numerical ranges.

In another embodiment, the at least one microsphere additive of the present invention is selected from a suitable UHMWPE (ultra-high molecular weight polyethylene) having a density in the range of about 0.931 g/cm³ to about 0.949 g/cm³, or about 0.932 g/cm³ to about 0.948 g/cm³, or about 0.933 g/cm³ to about 0.947 g/cm³, or about 0.934 g/cm³ to about 0.946 g/cm³, or about 0.935 g/cm³ to about 0.945 g/cm³, or about 0.936 g/cm³ to about 0.944 g/cm³, or about 0.937 g/cm³ to about 0.943 g/cm³, or about 0.938 g/cm³ to about 0.942 g/cm³, or about 0.939 g/cm³ to about 0.941 g/cm³, or even about 0.940 g/cm³. In another embodiment, the at least one microsphere additive of the present invention is selected from a suitable UHMWPE (ultra-high molecular weight polyethylene) having a specific gravity in the range of about 0.925 to about 0.945, or about 0.926 to about 0.944, or about 0.927 to about 0.943, or about 0.928 to about 0.942, or about 0.929 to about 0.941, or about 0.930 to about 0.940, or about 0.931 to about 0.939, or about 0.932 to about 0.938, or about 0.933 to about 0.937, or about 0.934 to about 0.936, or even about 0.935. In another embodiment, the at least one microsphere additive of the present invention is selected from any suitable polymeric material listed above, or even a suitable UHMWPE (ultra-high molecular weight polyethylene), where such polymeric material has a coefficient of friction (dry condition test) of less than or equal to about 0.2, or less than or equal to about 0.19, or less than or equal to about 0.18, or less than or equal to about 0.17, or less than or equal to about 0.16, or less than or equal to about 0.15, or less than or equal to about 0.14, or less than or equal to about 0.13, or less than or equal to about 0.12, or less than or equal to about 0.11, or even less than or equal to about 0.1. Here, as well as elsewhere in the specification and claims, individual numerical values can be combined to form additional, or even new/non-disclosed, numerical ranges.

In still another embodiment, any of the polymeric materials used to form the at least one microsphere additive for use in conjunction with the stoppers of the present invention can have any combination of two, three or more, or even four, of any of the various chemical and/or physical properties disclosed herein.

### STOPPER POLYMERIC BLEND

In one embodiment, the blend of the present invention is a combination of at least one base polymeric material with at least one microsphere additive in combination with at least one plasticizer and at least one filler (hereinafter referred to as the “blended polymeric material”). As used herein, “plasticizer” means a material known in the art that has a molecular weight lower than that of the base polymeric material having the lowest molecular weight (if more than one base polymeric material is used in connection with the present invention). Suitable plasticizers include any plasticizers known in the art for use with the one or more base polymeric materials disclosed herein. Non-limiting examples include citrates/citric acid esters, epoxidized soybean oil (ESBO), epoxidized linseed oil (ELO), castor oil, silicone oil, mineral oil, paraffinic oils, aromatic oils, naphthenic oils, palm oil, other vegetable oils, suitable starches, suitable sugars (e.g., isosorbide esters), di-2-ethylhexyl-phthalate (DEHP), etc.

In one embodiment, the at least one plasticizer is typically added to the blended polymeric material of the present invention at an amount less than or equal to about 30 percent by weight, or less than or equal to 29.5 percent by weight, or less than or equal to about 29 percent by weight, or less than or equal to about 28.5 percent by weight, or less than or equal to about 28 percent by weight, or less than or equal to about 27.5 percent by weight, or less than or equal to about 27 percent by weight, or less than or equal to about 26.5 percent by weight, or less than or equal to about 26 percent by weight, or less than or equal to about 25.5 percent by weight, or less than or equal to about 25 percent by weight, or less than or equal to about 24.5 percent by weight, or less than or equal to about 24 percent by weight, or less than or equal to about 23.5 percent by weight, or less than or equal to about 23 percent by weight, or less than or equal to about 22.5 percent by weight, or less than or equal to about 22 percent by weight, or less than or equal to about 21.5 percent by weight, or less than or equal to about 21 percent by weight, or less than or equal to about 20.5 percent by weight, or less than or equal to about 20 percent by weight, or less than or equal to about 19.5 percent by weight, or less than or equal to about 19 percent by weight, or less than or equal to about 18.5 percent by weight, or less than or equal to about 18 percent by weight, or less than or equal to about 17.5 percent by weight, or less than or equal to about 17 percent by weight, or less than or equal to about 16.5 percent by weight, or less than or equal to about 16 percent by weight, or less than or equal to about 15.5 percent by weight, or less than or equal to 15 percent by weight, or less than or equal to about 14.5 percent by weight, or less than or equal to about 14 percent by weight, or less than or equal to about 13.5 percent by weight, or less than or equal to about 13 percent by weight, or less than or equal to about 12.5 percent by weight, or less than or equal to about 12 percent by weight, or less than or equal to about 11.5 percent by weight, or less than or equal to about 11 percent by weight, or less than or equal to about 10.5 percent by weight, or less than or equal to about 10 percent by weight, or less than or equal to about 9.5 percent by weight, or less than or equal to about 9 percent by weight, or less than or equal to about 8.5 percent by weight, or less than or equal to about 8 percent by weight, or less than or equal to about 7.5 percent by weight, or less than or equal to about 7 percent by weight, or less than or equal to about 6.5 percent by weight, or less than or equal to about 6 percent by weight, or less than or equal to about 5.5 percent by weight, or less than or equal to about 5 percent by weight, or less than or equal to about 4.5 percent by weight, or less than or equal to about 4 percent by weight, or less than or equal to about 3.5 percent by weight, or less than or equal to about 3 percent by weight, or less than or equal to about 2.5 percent by weight, or less than or equal to about 2 percent by weight, or less than or equal to about 1.5 percent by weight, or less than or equal to about 1 percent by weight, or even less than or equal to about 0.5 percent by weight based on the weight amount of the one or more base polymeric materials present. Here, as well as elsewhere in the specification and claims, individual numerical values can be combined to form additional, or even new/non-disclosed, numerical ranges.

In one embodiment, the at least one plasticizer is typically added to the blended polymeric material of the present invention at an amount less than or equal to about 10 percent by weight, or less than or equal to about 9.9 percent by weight, or less than or equal to about 9.8 percent by weight, or less than or equal to about 9.7 percent by weight, or less than or equal to about 9.6 percent by weight, or less than or equal to about 9.5 percent by weight, or less than or equal to about 9.4 percent by weight, or less than or equal to about 9.3 percent by weight, or less than or equal to about 9.2 percent by weight, or less than or equal to about 9.1 percent by weight, or less than or equal to about 9 percent by weight, or less than or equal to about 8.9 percent by weight, or less than or equal to about 8.8 percent by weight, or less than or equal to about 8.7 percent by weight, or less than or equal to about 8.6 percent by weight, or less than or equal to about 8.5 percent by weight, or less than or equal to about 8.4 percent by weight, or less than or equal to about 8.3 percent by weight, or less than or equal to about 8.2 percent by weight, or less than or equal to about 8.1 percent by weight, or less than or equal to about 8 percent by weight, or less than or equal to about 7.9 percent by weight, or less than or equal to about 7.8 percent by weight, or less than or equal to about 7.7 percent by weight, or less than or equal to about 7.6 percent by weight, or less than or equal to about 7.5 percent by weight, or less than or equal to about 7.4 percent by weight, or less than or equal to about 7.3 percent by weight, or less than or equal to about 7.2 percent by weight, or less than or equal to about 7.1 percent by weight, or less than or equal to about 7 percent by weight, or less than or equal to about 6.9 percent by weight, or less than or equal to about 6.8 percent by weight, or less than or equal to about 6.7 percent by weight, or less than or equal to about 6.6 percent by weight, or less than or equal to about 6.5 percent by weight, or less than or equal to about 6.4 percent by weight, or less than or equal to about 6.3 percent by weight, or less than or equal to about 6.2 percent by weight, or less than or equal to about 6.1 percent by weight, or less than or equal to about 6 percent by weight, or less than or equal to about 5.9 percent by weight, or less than or equal to about 5.8 percent by weight, or less than or equal to about 5.7 percent by weight, or less than or equal to about 5.6 percent by weight, or less than or equal to about 5.5 percent by weight, or less than or equal to about 5.4 percent by weight, or less than or equal to about 5.3 percent by weight, or less than or equal to about 5.2 percent by weight, or less than or equal to about 5.1 percent by weight, or less than or equal to about 5 percent by weight, or less than or equal to about 4.9 percent by weight, or less than or equal to about 4.8 percent by weight, or less than or equal to about 4.7 percent by weight, or less than or equal to about 4.6 percent by weight, or less than or equal to about 4.5 percent by weight, or less than or equal to about 4.4 percent by weight, or less than or equal to about 4.3 percent by weight, or less than or equal to about 4.2 percent by weight, or less than or equal to about 4.1 percent by weight, or less than or equal to about 4 percent by weight, or less than or equal to about 3.9 percent by weight, or less than or equal to about 3.8 percent by weight, or less than or equal to about 3.7 percent by weight, or less than or equal to about 3.6 percent by weight, or less than or equal to about 3.5 percent by weight, or less than or equal to about 3.4 percent by weight, or less than or equal to about 3.3 percent by weight, or less than or equal to about 3.2 percent by weight, or less than or equal to about 3.1 percent by weight, or less than or equal to about 3 percent by weight, or less than or equal to about 2.9 percent by weight, or less than or equal to about 2.8 percent by weight, or less than or equal to about 2.7 percent by weight, or less than or equal to about 2.6 percent by weight, or less than or equal to about 2.5 percent by weight, or less than or equal to about 2.4 percent by weight, or less than or equal to about 2.3 percent by weight, or less than or equal to about 2.2 percent by weight, or less than or equal to about 2.1 percent by weight, or less than or equal to about 2 percent by weight, or less than or equal to about 1.9 percent by weight, or less than or equal to about 1.8 percent by weight, or less than or equal to about 1.7 percent by weight, or less than or equal to about 1.6 percent by weight, or less than or equal to about 1.5 percent by weight, or less than or equal to about 1.4 percent by weight, or less than or equal to about 1.3 percent by weight, or less than or equal to about 1.2 percent by weight, or less than or equal to about 1.1 percent by weight, or less than or equal to about 1 percent by weight, or less than or equal to about 0.9 percent by weight, or less than or equal to about 0.8 percent by weight, or less than or equal to about 0.7 percent by weight, or less than or equal to about 0.6 percent by weight, or even less than or equal to about 0.5 percent by weight based on the weight amount of the one or more base polymeric materials present. Here, as well as elsewhere in the specification and claims, individual numerical values can be combined to form additional, or even new/non-disclosed, numerical ranges.

In one embodiment, the at least one filler of the present invention is selected from carbon fibers, talc, calcium carbonate, silica, carbon black, mica, clay, or combinations of two or more thereof. In another embodiment a super abrasion furnace grade carbon black with medium structure and high surface area will be utilized in connection with any of the base polymeric materials disclosed herein. In another embodiment, the at least one filler of the present invention is any suitable inorganic filler that is able to be utilized in connection with any of the base polymeric materials disclosed herein. In still another embodiment, suitable filler materials for the various base polymeric materials disclosed herein include, but are not limited to, various silica compounds including silica compounds treated with one or more coupling agents (e.g., a silane coupling agent), graphene, single or multiple walled carbon nanotubes (CNT). Additionally, other suitable filler materials for the polymeric materials disclosed herein are known in the art and as such are omitted herein for the sake of brevity.

In one embodiment, the at least one filler is typically added to the blended polymeric material of the present invention at an amount less than or equal to about 20 percent by weight, or less than or equal to 19.5 percent by weight, or less than or equal to about 19 percent by weight, or less than or equal to about 18.5 percent by weight, or less than or equal to about 18 percent by weight, or less than or equal to about 17.5 percent by weight, or less than or equal to about 17 percent by weight, or less than or equal to about 16.5 percent by weight, or less than or equal to about 16 percent by weight, or less than or equal to about 15.5 percent by weight.

In one embodiment, the at least one filler is typically added to the blended polymeric material of the present invention at an amount less than or equal to about 15 percent by weight, or less than or equal to about 14.5 percent by weight, or less than or equal to about 14 percent by weight, or less than or equal to about 13.5 percent by weight, or less than or equal to about 13 percent by weight, or less than or equal to about 12.5 percent by weight, or less than or equal to about 12 percent by weight, or less than or equal to about 11.5 percent by weight, or less than or equal to about 11 percent by weight, or less than or equal to about 10.5 percent by weight, or less than or equal to about 10 percent by weight, or less than or equal to about 9.5 percent by weight, or less than or equal to about 9 percent by weight, or less than or equal to about 8.5 percent by weight, or less than or equal to about 8 percent by weight, or less than or equal to about 7.5 percent by weight, or less than or equal to about 7 percent by weight, or less than or equal to about 6.5 percent by weight, or less than or equal to about 6 percent by weight, or less than or equal to about 5.5 percent by weight, or less than or equal to about 5 percent by weight, or less than or equal to about 4.5 percent by weight, or less than or equal to about 4 percent by weight, or less than or equal to about 3.5 percent by weight, or less than or equal to about 3 percent by weight, or less than or equal to about 2.5 percent by weight, or less than or equal to about 2 percent by weight, or less than or equal to about 1.5 percent by weight, or less than or equal to about 1 percent by weight, or even less than or equal to about 0.5 percent by weight based on the weight amount of the one or more base polymeric materials present. Here, as well as elsewhere in the specification and claims, individual numerical values can be combined to form additional, or even new/non-disclosed, numerical ranges.

In one embodiment, the at least one filler is typically added to the blended polymeric material of the present invention at an amount less than or equal to about 10 percent by weight, or less than or equal to about 9.9 percent by weight, or less than or equal to about 9.8 percent by weight, or less than or equal to about 9.7 percent by weight, or less than or equal to about 9.6 percent by weight, or less than or equal to about 9.5 percent by weight, or less than or equal to about 9.4 percent by weight, or less than or equal to about 9.3 percent by weight, or less than or equal to about 9.2 percent by weight, or less than or equal to about 9.1 percent by weight, or less than or equal to about 9 percent by weight, or less than or equal to about 8.9 percent by weight, or less than or equal to about 8.8 percent by weight, or less than or equal to about 8.7 percent by weight, or less than or equal to about 8.6 percent by weight, or less than or equal to about 8.5 percent by weight, or less than or equal to about 8.4 percent by weight, or less than or equal to about 8.3 percent by weight, or less than or equal to about 8.2 percent by weight, or less than or equal to about 8.1 percent by weight, or less than or equal to about 8 percent by weight, or less than or equal to about 7.9 percent by weight, or less than or equal to about 7.8 percent by weight, or less than or equal to about 7.7 percent by weight, or less than or equal to about 7.6 percent by weight, or less than or equal to about 7.5 percent by weight, or less than or equal to about 7.4 percent by weight, or less than or equal to about 7.3 percent by weight, or less than or equal to about 7.2 percent by weight, or less than or equal to about 7.1 percent by weight, or less than or equal to about 7 percent by weight, or less than or equal to about 6.9 percent by weight, or less than or equal to about 6.8 percent by weight, or less than or equal to about 6.7 percent by weight, or less than or equal to about 6.6 percent by weight, or less than or equal to about 6.5 percent by weight, or less than or equal to about 6.4 percent by weight, or less than or equal to about 6.3 percent by weight, or less than or equal to about 6.2 percent by weight, or less than or equal to about 6.1 percent by weight, or less than or equal to about 6 percent by weight, or less than or equal to about 5.9 percent by weight, or less than or equal to about 5.8 percent by weight, or less than or equal to about 5.7 percent by weight, or less than or equal to about 5.6 percent by weight, or less than or equal to about 5.5 percent by weight, or less than or equal to about 5.4 percent by weight, or less than or equal to about 5.3 percent by weight, or less than or equal to about 5.2 percent by weight, or less than or equal to about 5.1 percent by weight, or less than or equal to about 5 percent by weight, or less than or equal to about 4.9 percent by weight, or less than or equal to about 4.8 percent by weight, or less than or equal to about 4.7 percent by weight, or less than or equal to about 4.6 percent by weight, or less than or equal to about 4.5 percent by weight, or less than or equal to about 4.4 percent by weight, or less than or equal to about 4.3 percent by weight, or less than or equal to about 4.2 percent by weight, or less than or equal to about 4.1 percent by weight, or less than or equal to about 4 percent by weight, or less than or equal to about 3.9 percent by weight, or less than or equal to about 3.8 percent by weight, or less than or equal to about 3.7 percent by weight, or less than or equal to about 3.6 percent by weight, or less than or equal to about 3.5 percent by weight, or less than or equal to about 3.4 percent by weight, or less than or equal to about 3.3 percent by weight, or less than or equal to about 3.2 percent by weight, or less than or equal to about 3.1 percent by weight, or less than or equal to about 3 percent by weight, or less than or equal to about 2.9 percent by weight, or less than or equal to about 2.8 percent by weight, or less than or equal to about 2.7 percent by weight, or less than or equal to about 2.6 percent by weight, or less than or equal to about 2.5 percent by weight, or less than or equal to about 2.4 percent by weight, or less than or equal to about 2.3 percent by weight, or less than or equal to about 2.2 percent by weight, or less than or equal to about 2.1 percent by weight, or less than or equal to about 2 percent by weight, or less than or equal to about 1.9 percent by weight, or less than or equal to about 1.8 percent by weight, or less than or equal to about 1.7 percent by weight, or less than or equal to about 1.6 percent by weight, or less than or equal to about 1.5 percent by weight, or less than or equal to about 1.4 percent by weight, or less than or equal to about 1.3 percent by weight, or less than or equal to about 1.2 percent by weight, or less than or equal to about 1.1 percent by weight, or less than or equal to about 1 percent by weight, or less than or equal to about 0.9 percent by weight, or less than or equal to about 0.8 percent by weight, or less than or equal to about 0.7 percent by weight, or less than or equal to about 0.6 percent by weight, or even less than or equal to about 0.5 percent by weight based on the weight amount of the one or more base polymeric materials present. Here, as well as elsewhere in the specification and claims, individual numerical values can be combined to form additional, or even new/non-disclosed, numerical ranges.

In one embodiment, the ratio of the weight amount of the at least one plasticizer to the weight amount of the at least one filler added to the blended polymeric material of the present invention is in the range of about 2:1 plasticizer to filler to about 1:5 plasticizer to filler based on the weight amount of the one or more base polymeric materials present. In another embodiment, the ratio of the weight amount of the at least one plasticizer to the weight amount of the at least one filler added to the blended polymeric material of the present invention is in the range of about 1.9:1 plasticizer to filler to about 1:4.9 plasticizer to filler, or from about 1.8:1 plasticizer to filler to about 1:4.8 plasticizer to filler, or from about 1.7:1 plasticizer to filler to about 1:4.7 plasticizer to filler, or from about 1.6:1 plasticizer to filler to about 1:4.6 plasticizer to filler, or from about 1.5:1 plasticizer to filler to about 1:4.5 plasticizer to filler, or from about 1.4:1 plasticizer to filler to about 1:4.4 plasticizer to filler, or from about 1.3:1 plasticizer to filler to about 1:4.3 plasticizer to filler, or from about 1.2:1 plasticizer to filler to about 1:4.2 plasticizer to filler, or from about 1.1:1 plasticizer to filler to about 1:4.1 plasticizer to filler, or even from about 1:1 plasticizer to filler to about 1:4 plasticizer to filler based on the weight amount of the one or more base polymeric materials present. Here, as well as elsewhere in the specification and claims, individual numerical values can be combined to form additional, or even new/non-disclosed, numerical ranges.

In still another embodiment, the ratio of the weight amount of the at least one plasticizer to the weight amount of the at least one filler added to the blended polymeric material of the present invention is in the range of about 1:1 plasticizer to filler to about 1:4 plasticizer to filler, or from about 1:1.1 plasticizer to filler to about 1:3.9 plasticizer to filler, or from about 1:1.2 plasticizer to filler to about 1:3.8 plasticizer to filler, or from about 1:1.3 plasticizer to filler to about 1:3.7 plasticizer to filler, or from about 1:1.4 plasticizer to filler to about 1:3.6 plasticizer to filler, or from about 1:1.5 plasticizer to filler to about 1:3.5 plasticizer to filler, or from about 1:1.6 plasticizer to filler to about 1:3.4 plasticizer to filler, or from about 1:1.7 plasticizer to filler to about 1:3.3 plasticizer to filler, or from about 1:1.8 plasticizer to filler to about 1:3.2 plasticizer to filler, or from about 1:1.9 plasticizer to filler to about 1:3.1 plasticizer to filler, or from about 1:2 plasticizer to filler to about 1:3 plasticizer to filler, or from about 1:2.1 plasticizer to filler to about 1:2.9 plasticizer to filler, or from about 1:2.2 plasticizer to filler to about 1:2.8 plasticizer to filler, or from about 1:2.3 plasticizer to filler to about 1:2.7 plasticizer to filler, or from about 1:2.4 plasticizer to filler to about 1:2.6 plasticizer to filler, or even about 1:2.5 plasticizer to filler based on the weight amount of the one or more base polymeric materials present. Here, as well as elsewhere in the specification and claims, individual numerical values can be combined to form additional, or even new/non-disclosed, numerical ranges.

In one embodiment, the weight amount of the at least one microsphere additive of the present invention added to the blended polymeric material of the present invention is in the range of about 26 percent by weight to about 42 percent by weight based on the weight amount of the one or more base polymeric materials present. In another embodiment, the weight amount of the at least one microsphere additive of the present invention added to the blended polymeric material of the present invention is in the range of about 26.5 percent by weight to about 41.5 percent by weight, or from about 27 percent by weight to about 41 percent by weight, or from about 27.5 percent by weight to about 40.5 percent by weight, or from about 28 percent by weight to about 40 percent by weight, or from about 28.5 percent by weight to about 39.5 percent by weight, or from about 29 percent by weight to about 39 percent by weight, or from about 29.5 percent by weight to about 38.5 percent by weight, or from about 30 percent by weight to about 38 percent by weight, or from about 30.5 percent by weight to about 37.5 percent by weight, or from about 31 percent by weight to about 37 percent by weight, or from about 31.5 percent by weight to about 36.5 percent by weight, or from about 32 percent by weight to about 36 percent by weight, or from about 32.5 percent by weight to about 35.5 percent by weight, or from about 33 percent by weight to about 35 percent by weight, or from about 33.5 percent by weight to about 34.5 percent by weight, or even about 33 percent by weight based on the weight amount of the one or more base polymeric materials present.

In another embodiment, the blended polymeric material further comprises one or more non-microsphere-based additives, one or more additional fillers, one or more additional processing aids, one or more oils, one or more dyes or colorants, or combinations of two or more thereof.

While not wishing to be bound to any one advantage, the blended polymeric material according to the present invention achieves a reduction in the coefficient of friction for any stopper, or other object, made therefrom due to the inclusion of the at least one microsphere additive (e.g., ultra-high molecular weight polyethylene powder particles) as the microsphere additive functions as small bearings between the stopper surface and the surface to be sealed. At the various loading levels disclosed herein, the at least one microsphere additive is present on the surface of a stopper, or other object, since the microspheres are embedded in, and thus bonded to, the blended polymeric material that is used to form a stopper, or other object, in accordance with the present invention. The externally present microspheres act a barrier which can reduce the risk for other material in the blended polymeric material of the stopper, or other object, to leach into a drug, or other compounded that comes into contact with same. Additionally, when used in a stopper, or some other object that undergoes motion, the externally present microspheres are at least partially consumed as the two components (e.g., syringe and barrel) move axially with respect to one another.

As such, in one embodiment of the present invention the stopper and/or the walls of any respective syringe may be substantially free of a lubricant. The lubricant may include a silicone oil. As used herein “substantially free of a lubricant” indicates that a lubricant is not intentionally added to the base polymeric material and/or the blended polymeric material of the present invention, and any walls that such a stopper for example comes into contact are also substantially free of a lubricant, such that any trace amounts of lubricant present are incidental. The base polymeric material and/or the blended polymeric material of the present invention and thus any stopper formed therefrom, as well as any corresponding walls such a stopper comes into contact with, may be completely free of a lubricant. Non-limiting examples of lubricants include silicone or hydrocarbon oils, such as mineral oils, peanut oil, vegetable oils, and the like.

In still another embodiment, complimentary additives such as oil, plasticizer, or liquid polymer may be added to further help maintain the glide force level during use by “replacing” surface lubricant removed by the sliding action. Such compounds are discussed in United States Patent Application No. 18/239,896, filed August 30, 2023, which is hereby incorporated by reference in its entirety.

According to some non-limiting embodiments the blended polymeric material of the present invention can be combined with or aspects from United States Patent Application No. 18/239,896 base polymeric material is, for example, a self-lubricating rubber formed from a rubber composition including a halogenated isobutylene-isoprene co-polymer and at least one of (1) clay minerals or silica and/or (2) a liquid polyisoprene and butadiene homopolymer.

In this instance, as well as all others in this patent application, any suitable medical device may be formed from the blending polymeric material disclosed herein, or the combination of polymeric material from United States Patent Application No. 18/239,896 may be combined with the at least one microsphere additive disclosed herein, to form a syringe assembly, drug cartridge, needleless injector, liquid dispensing device, liquid metering device, sample collection tube or plate assembly, catheter, and vial. The rubber component may include a pierceable septum. The medical device may include a drug delivery system for injecting a medicament, where the container includes a syringe barrel configured to receive the medicament, where the rubber component includes a stopper configured to slide against the walls within the syringe barrel from a pre-use position to a post-use position.

In the instance where the invention of United States Patent Application No. 18/239,896 is combined with the at least one microsphere additive disclosed herein, the halogenated isobutylene-isoprene co-polymer may include a chloro-isobutylene-isoprene co-polymer. This alternative base polymeric material may further include the clay minerals or silica. The clay minerals may include calcined magnesium silicate clay or aluminum silicate clay. The alternative base polymeric material may further include the liquid polyisoprene and butadiene homopolymer. The liquid polyisoprene and butadiene homopolymer may have a weight average molecular weight of from 20,000 to 50,000 g/mol. The alternative base polymeric material may include from 50 to 100 phr of the halogenated isobutylene-isoprene co-polymer; from 30 to 60 phr of the clay minerals or silica; and from 3 to 30 phr of the liquid polyisoprene and butadiene homopolymer.

Given the above, the present invention relates to one or more blended polymeric materials that include therein at least one microsphere additive, and preferably two polyethylene microsphere additives, that are added thereto to produce a self-lubricating effect in same. In one embodiment, the at least one microsphere additive is formed from a suitable polyethylene compound and is added to a suitable base polymeric and/or rubber compound to produce a blended polymeric material that is self-lubricating. In one instance, the at least one polyethylene microsphere additive is formed from an ultra-high molecular weight polyethylene powder.

In one embodiment, the present invention is a blended polymeric material comprising at least one base polymeric material; and at least one microsphere additive, wherein the base polymeric material and the at least one microsphere additive are blended together to yield a blended polymeric material that is self-lubricating. In another embodiment, the blended polymeric material disclosed herein has therein at least one microsphere additive at a range of about 30 percent by weight to about 38 percent by weight based on the weight of the base polymeric material present. In still another embodiment, the blended polymeric material of the present invention comprises at least one microsphere additive is selected from ultra-high molecular weight polyethylene powder. In still another embodiment, the blended polymeric material of the present invention comprises at least one ultra-high molecular weight polyethylene powder microsphere additive having a weight average molecular weight (Mw) in the range of about 2,000,000 g/mol to about 7,500,000 g/mol.

In still another embodiment, the blended polymeric material of the present invention comprises at least one ultra-high molecular weight polyethylene powder microsphere additive having a particle size in the range of about 20 μm to about 29 μm. In still another embodiment, the blended polymeric material of the present invention comprises at least one plasticizer and at least one filler. In still another embodiment, the blended polymeric material of the present invention comprises at least one plasticizer in the blended polymeric material in an amount less than or equal to about 15 percent by weight based on the weight amount of the one or more base polymeric materials present. In still another embodiment, the blended polymeric material of the present invention comprises at least one filler in the blended polymeric material in an amount less than or equal to about 15 percent by weight based on the weight amount of the one or more base polymeric materials present. In still another embodiment, the blended polymeric material of the present invention comprises the ratio of the weight amount of the at least one plasticizer to the weight amount of the at least one filler present in the blended polymeric material is about 1:2. In still another embodiment, the blended polymeric material of the present invention comprises the base polymeric material that forms part of the blended polymeric material is an ultra-low Tg polybutadiene thermoset rubber having a glass transition temperature (Tg) that is less than or equal to about -50°C.

In still another embodiment, the blended polymeric material of the present invention is used to form any suitable medical device such as a stopper comprising a stopper body and at least one sealing rib formed on the stopper body, wherein the stopper body and the at least one sealing rib are formed from any of the blended polymeric materials disclosed herein that comprise at least one base polymeric material and at least one microsphere additive, wherein the base polymeric material and the at least one microsphere additive are blended together to yield a blended polymeric material that is self-lubricating.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure that are known or customarily practiced in the art to which this disclosure pertains and which fall within the limits of the appended claims.

What is claimed is:

1. A blended polymeric material comprising:
at least one base polymeric material; and
at least one microsphere additive,
wherein the base polymeric material and the at least one microsphere additive are blended together to yield a blended polymeric material that is self-lubricating.

2. The blended polymeric material of claim 1, wherein the at least one microsphere additive is present in the at least one blended polymeric material at a range of about 26 percent by weight to about 42 percent by weight and preferably 30 percent by weight to about 38 percent by weight, based on the weight of the base polymeric material present.

3. The blended polymeric material of claim 1, wherein the at least one microsphere additive is selected from ultra-high molecular weight polyethylene powder.

4. The blended polymeric material of claim 3, wherein the at least one ultra-high molecular weight polyethylene powder microsphere additive has a weight average molecular weight (Mw) in the range of about 2,000,000 g/mol to about 7,500,000 g/mol.

5. The blended polymeric material of claim 3, wherein the at least one ultra-high molecular weight polyethylene powder microsphere additive has a particle size in the range of about 10 μm to about 40 μm and preferably from 20 μm to about 29 μm.

6. The blended polymeric material of claim 1, wherein the blended polymeric material further comprises at least one plasticizer and at least one filler.

7. The blended polymeric material of claim 6, wherein the at least one plasticizer is present in the blended polymeric material in an amount less than or equal to about 30 percent by weight or alternately 15 percent by weight based on the weight amount of the one or more base polymeric materials present.

8. The blended polymeric material of claim 6, wherein the at least one filler is present in the blended polymeric material in an amount less than or equal to about 15 percent by weight based on the weight amount of the one or more base polymeric materials present.

9. The blended polymeric material of claim 6, wherein the ratio of the weight amount of the at least one plasticizer to the weight amount of the at least one filler present in the blended polymeric material is about 1:2.

10. The blended polymeric material of claim 1, wherein the base polymeric material is an ultra-low Tg polybutadiene thermoset rubber having a glass transition temperature (Tg) that is less than or equal to about -50 °C.

11. A stopper comprising:
a stopper body; and
at least one sealing rib formed on the stopper body, wherein the stopper body and the at least one sealing rib are formed from a blended polymeric material comprising:
at least one base polymeric material; and
at least one microsphere additive,
wherein the base polymeric material and the at least one microsphere additive are blended together to yield a blended polymeric material that is self-lubricating.

12. The stopper of claim 11, wherein the at least one microsphere additive is present in the at least one blended polymeric material at a range of about 30 percent by weight to about 38 percent by weight based on the weight of the base polymeric material present.

13. The stopper of claim 11, wherein the at least one microsphere additive is selected from ultra-high molecular weight polyethylene powder.

14. The stopper of claim 13, wherein the at least one ultra-high molecular weight polyethylene powder microsphere additive has a weight average molecular weight (Mw) in the range of about 2,000,000 g/mol to about 7,500,000 g/mol.

15. The stopper of claim 13, wherein the at least one ultra-high molecular weight polyethylene powder microsphere additive has a particle size in the range of about 10 μm to about 40 μm.

16. The stopper of claim 13, wherein the at least one ultra-high molecular weight polyethylene powder microsphere additive has a particle size in the range of about 10 μm to about 30 μm.

17. The stopper of claim 11, wherein the blended polymeric material further comprises at least one plasticizer and at least one filler.

18. The stopper of claim 17, wherein the at least one plasticizer is present in the blended polymeric material in an amount less than or equal to about 15 percent by weight based on the weight amount of the one or more base polymeric materials present.

19. The stopper of claim 17, wherein the at least one filler is present in the blended polymeric material in an amount less than or equal to about 15 percent by weight based on the weight amount of the one or more base polymeric materials present.

20. The stopper of claim 17, wherein the ratio of the weight amount of the at least one plasticizer to the weight amount of the at least one filler present in the blended polymeric material is about 1-2..

21. The stopper of claim 11, wherein the base polymeric material is an ultra-low Tg polybutadiene thermoset rubber having a glass transition temperature (Tg) that is less than or equal to about -50 °C.
